(19) United States
(12) Patent Application Publication
(10) Pub. No.: US 2008/0022640 A1
(43) Pub. Date: Jan. 31, 2008

(54) Housing for a critical process air handling unit and a critical process air handling unit incorporating the same

(75) Inventors: Bruce Anthony Paulson, Owatonna, MN (US); Thomas John Heisler, Owatonna, MN (US); David Dewain Nelson, Albert Lea, MN (US)

Correspondence Address: RADER FISHMAN & GRAUER PLLC, LION BUILDING, 1233 20TH STREET N.W., SUITE 501, WASHINGTON, DC, 20036, US

(73) Assignee: EVAPCO, Inc.

(21) Appl. No.: 11/495,485

(22) Filed: Jul. 31, 2006

(51) Int. Cl. B01D 46/00

(52) U.S. Cl. 55/467

(57) ABSTRACT

A housing unit, alone and incorporated into a critical process air handling unit, includes a hollow generally cylindrical body, a damper, a filter mounting structure and a stand structure. The hollow generally cylindrical body extends along and about a longitudinal axis and has a generally cylindrical outer surface and a generally cylindrical inner surface defining an inlet opening, an outlet opening and a passageway extending therebetween. The generally cylindrical body has a drain hole and an entry way formed through and between the inner and outer surfaces. The damper assembly is connected to the generally cylindrical body at the inlet opening and the filter mounting structure is connected to the generally cylindrical body at the outlet opening. The stand structure is operative to support the generally cylindrical body above a support surface in a manner such that the longitudinal axis is oriented generally horizontally and the drain hole is disposed in facial opposition to the support surface.

### FIELD OF THE INVENTION

The present invention relates to a critical process air handling unit. More particularly, the present invention is directed to a housing for the critical process air handling unit.

### BACKGROUND OF THE INVENTION

Companies, such as those in the food industry, require critical process air handling units that can be cleaned on the interior. FIGS. 1-3 illustrate a conventional rectangularly-shaped critical process air handling unit 2. The conventional critical process air handling unit 2 intakes contaminated air (represented by arrows entering the critical process air handling unit 2) and processes the contaminated air as it passes through critical process air handling unit 2 in order to output processed air (represented by arrows exiting the critical process air handling unit 2) as de-contaminated, filtered and selectively heated or cooled. The air being processed can be either heat or cooled depending upon the requirements of the user.

The conventional critical process air handling unit 2 includes a rectangularly-shaped housing 4, a damper assembly 6 connected to the housing 4 at an inlet opening 8, a filter mounting structure 10 connected to the housing 4 at an outlet opening 12, a filter 14 mounted to the filter mounting structure 10, a fan assembly 16 connected to a fan assembly wall 18 interiorly of the housing 4, a pre-filter mounting structure 20 connected to a pre-filter mounting structure wall 22, a pre-filter 24, a UV light assembly 26 connected to a light assembly wall 28 and a heat exchanger unit 30. By way of example only, four shims in the form of legs 32 provide a stand structure to support the housing 4 generally in a level manner above a support surface 33. A floor 34 is secured to floor joists 36. As is known in the art, upon energizing the UV light assembly 26, the heat exchanger unit 30 and the fan assembly 16, the contaminated air is drawn through the damper assembly 6, the pre-filter 24, the heat exchanger unit 30 and the UV light assembly 26 and forced through the filter 14 thereby outputting the processed air as de-contaminated, filtered and selectively heated or cooled relative to the contaminated air. By way of example only, the illustrated heat exchanger unit 30 includes both a cooling coil assembly 30a and a heating coil assembly 30b so that the processed air can be selectively heated or cooled depending upon the needs of the user. However, a skilled artisan would appreciate that a conventional heat exchanger unit might include either the cooling coil assembly or the heating coil assembly or both the cooling coil assembly and the heat coil asembly.

Such conventional critical process air handling units have many seams, corners and overlapping joints. By way of example only, the rectangularly-shaped housing 4 of the conventional critical process air handling unit 2 as best shown in FIG. 3 includes panels 38 overlapped onto a housing frame 40 and fastened thereto by fasteners 42 such as screws. A gasket 44 is disposed between the panels 38 and the housing frame 40 to provide an air-tight seal. Alternatively of or in addition to this gasket arrangement, seams formed by the adjacently-fastened panels 38 are filled with caulk 46. Further, the rectangularly-shaped housing 4 forms many interior corners.

A problem associated with such a conventional critical process air handling unit 2 is that the gaskets 44 and/or the caulk 46 deteriorate over time which, in turn, results in an undesirable leakage of contaminated air into the interior of the unit. Also, since many of conventional critical process air handling units must be cleaned interiorly, the interior corners, particularly three-dimensional corners, formed by the rectangularly-shaped housing 4 are somewhat difficult to clean.

It would be beneficial to provide a critical process air handling unit that can minimize the use of gaskets and/or caulking. It would also be beneficial to provide a critical process air handling unit that minimizes the number of corners to simplify cleaning of the interior of the critical process air handling unit. The present invention provides these benefits.

### OBJECTS AND SUMMARY OF THE INVENTION

It is an object of the invention to provide a cylindrical critical process air handling unit that minimizes the use of gaskets and/or caulking so as to minimize leakage of contaminated air into the interior thereof during operations.

It is another object of the invention to provide a cylindrical critical process air handling unit that minimizes the number of corners so as to simplify cleaning of its interior.

Accordingly, a housing unit and a critical process air handling unit of the present invention are hereinafter described.

The housing unit of the present invention includes a hollow cylindrical body, a damper, a filter mounting structure and a stand structure. The hollow cylindrical body extends along and about a longitudinal axis and has a cylindrical outer surface and a cylindrical inner surface defining an inlet opening, an outlet opening and a passageway extending therebetween. Also, the cylindrical body has a drain hole and an entry way formed through and between the inner and outer surfaces. The damper assembly is connected to the cylindrical body at the inlet opening and the filter mounting structure is connected to the cylindrical body at the outlet opening. The stand structure is operative to support the cylindrical body above a support surface in a manner such that the longitudinal axis is oriented generally horizontally and the drain hole is disposed in facial opposition to the support surface.

The critical process air handling unit of the present invention is adapted to intake contaminated air for processing as air passes therethrough and to output processed air and includes a housing, a damper assembly, a filter mounting structure, at least one filter, a fan assembly, a pre-filter mounting structure,

at least one pre-filter, a UV light assembly, a stand structure and a walk-on grating. The housing unit includes at least one hollow cylindrical body extending along and about a longitudinal axis and having a cylindrical outer surface and a cylindrical inner surface defining an inlet opening, an outlet opening and a passageway extending therebetween. The at least one cylindrical body has a drain hole and an entry way formed through and between the inner and outer surfaces. The damper assembly is connected to the cylindrical body at the inlet opening and includes a disk-shaped damper assembly panel member having an outer periphery and a damper unit mounted to the disk-shaped damper assembly panel member with a plurality of movable vanes operative for providing a variably-sized air inlet opening to control an amount of contaminated air flowing into the passageway. The cylindrical body and the disk-shaped damper assembly panel member are integrally connected to each other at the outer periphery of the disk-shaped damper assembly panel member.

The filter mounting structure is connected to the cylindrical body at the outlet opening and includes a disk-shaped filter mounting structure panel member and a lattice of filter support members forming a plurality of columns and rows of air outlet openings to permit processed air to flow out of the passageway. The filter mounting structure includes a disk-shaped filter mounting structure panel member and a lattice of filter support members forming a plurality of columns and rows of air outlet openings to permit processed air to flow out of the passageway. The disk-shaped filter mounting structure panel member and the cylindrical body are integrally connected to each other. The at least one filter is mounted to the filter mounting structure with the passageway adjacent the outlet opening.

The fan assembly is connected to the inner surface of the cylindrical body within the passageway. The pre-filter mounting structure is connected to the inner surface of the cylindrical body within the passageway. The at least one pre-filter is mounted to the pre-filter mounting structure. The UV light assembly is connected to the inner surface of the cylindrical body within the passageway and is operative to reduce air and surface contaminants. The heat exchanger unit is connected to the inner surface of the cylindrical body within the passageway. The stand structure is operative to support the cylindrical body above a support surface in a manner such that the longitudinal axis is oriented generally horizontally (i.e., perfectly horizontal or slightly inclined relative to perfectly horizontal) and the drain hole is disposed in facial opposition to the support surface. The walk-on grating in a form of a grate structure extends longitudinally and laterally and disposed within the passageway between the inlet opening and the outlet opening and between the entry way and the drain hole. Upon energizing the UV light assembly, the heat exchanger unit and the fan assembly, the contaminated air is drawn through the damper assembly, the at least one pre-filter, the heat exchanger unit and the UV light assembly and is forced through the at least one filter thereby outputting the processed air as de-contaminated, filtered and selectively heated or cooled relative to the contaminated air.

These objects and other advantages of the present invention will be better appreciated in view of the detailed description of the exemplary embodiments of the present invention with reference to the accompanying drawings, in which:

### BRIEF DESCRIPTION OF THE DRAWINGS

FIG. 1 is a perspective view of a conventional critical process air handling unit.

FIG. 2 consists of FIG. 2a that illustrates a side elevational view shown in cross-section of the conventional critical process air handling unit in FIG. 1 and FIG. 2b that illustrates an enlarged portion of FIG. 2a.

FIG. 3 is an enlarged, broken-away perspective view of a corner portion of the conventional critical process air handling unit taken at the circle labeled 3-3 in FIG. 1.

FIG. 4 is a perspective view of a first embodiment of a housing unit of the present invention with its damper assembly and its pre-filter mounting structure removed therefrom.

FIG. 5 is a perspective, partially-exploded view of the first embodiment of the housing unit of the present invention with its damper assembly and its pre-filter mounting structure assembled thereto and being exploded to illustrate a stand structure and a door assembly.

FIG. 6 is a side elevational view shown in cross-section of another exemplary embodiment of a critical process air handling unit of the present invention incorporating the housing unit.

FIG. 7 is a front elevational view of the damper assembly.

FIG. 8 is an enlarged, partial, cross-sectional view of a hollow cylinder body having a flange connected to the damper assembly taken at the circle labeled 8-8 in FIG. 6.

FIG. 9 is a front elevational view of the filter mounting structure.

FIG. 10 is a perspective view of the filter mounting structure.

FIG. 11 is an exploded perspective view of the hollow cylinder body having a walk-on grating and door assembly that is exploded away from its stand structure.

FIG. 12 is a perspective view of another embodiment of a critical process air handling unit of the present invention.

FIG. 13 is a side elevational view in cross-section of the critical process air handling unit of the present invention shown in FIG. 12.

FIG. 14 is a perspective view of yet another embodiment of a critical process air handling unit of the present invention.

FIG. 15 is an exploded perspective of a support structure employed with the critical process air handling unit of the present invention in FIG. 14.

FIG. 16 is a diagrammatical front view of the housing unit of the present invention with the hollow cylindrical body formed in an oval shape with its major central axis oriented vertically.

FIG. 17 is a diagrammatical front view of the housing unit of the present invention with the hollow cylindrical body formed in an oval shape with its major central axis oriented horizontally.

FIG. 18 is a diagrammatical front view of the housing unit of the present invention with the hollow cylindrical body formed in an oval shape with an opposing pair of parallel straight side portions.

FIG. 19 is a diagrammatical front view of the housing unit of the present invention with the hollow cylindrical body formed in an elliptical shape with its major central axis oriented vertically.

FIG. 20 is a diagrammatical front view of the housing unit of the present invention with the hollow cylindrical body formed in an oval elliptical shape with its major central axis oriented horizontally.

### DETAILED DESCRIPTION OF THE EXEMPLARY EMBODIMENTS

Hereinafter, embodiments of the present invention will be described with reference to the attached drawings. The structural components common to those of the prior art and the structural components common to respective embodiments of the present invention will be represented by the same reference numerals and repeated description thereof will be omitted.

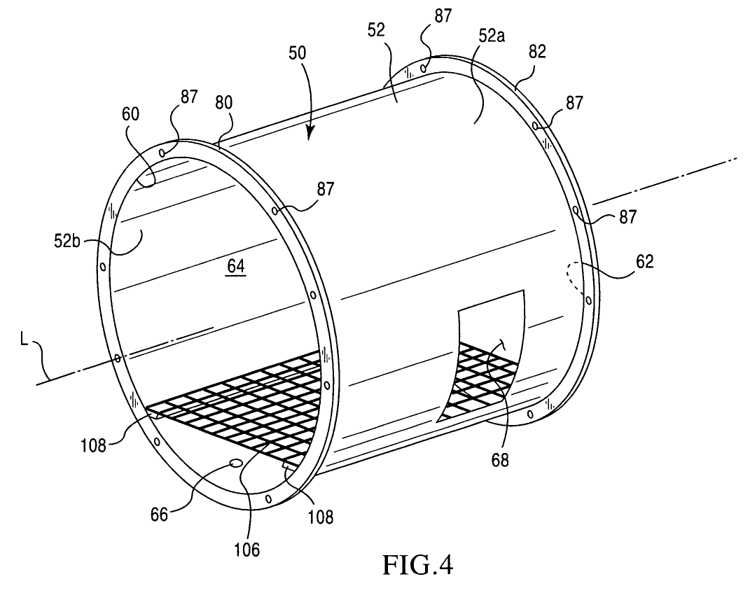

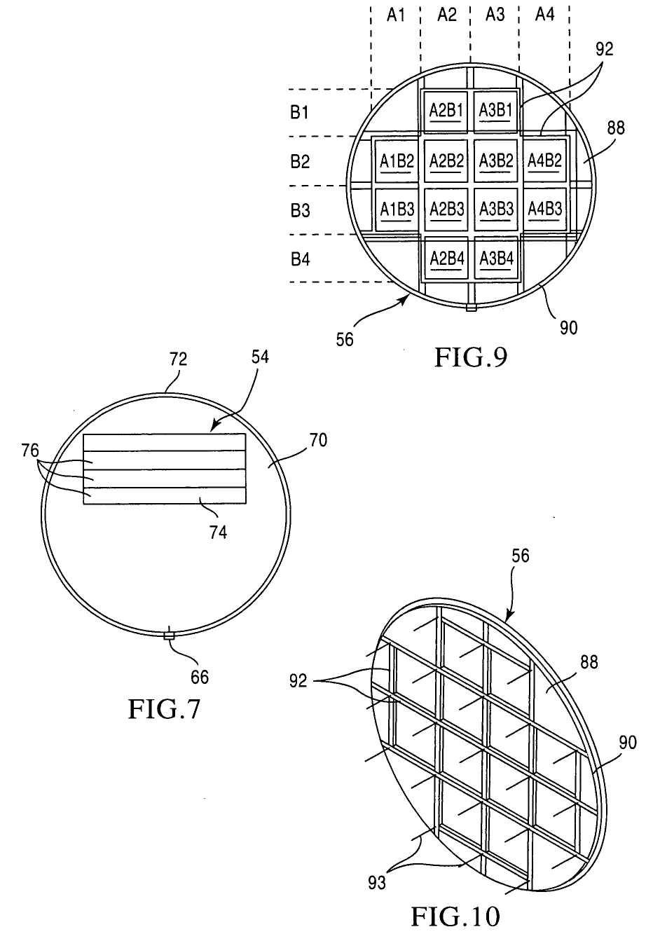

A first exemplary embodiment of a housing unit 50 of the present invention is hereinafter described with reference to FIGS. 4-11. The housing unit includes a hollow cylindrical body 52, a damper assembly 54, a filter mounting structure 56 and a stand structure 58 in the form of a pair of first legs 32a and a pair of second legs 32b. The hollow cylindrical body 52 extends along and about a longitudinal axis L and has a cylindrical outer surface 52a and a cylindrical inner surface 52b. The cylindrical inner surface 52b defines an inlet opening 60, an outlet opening 62 and a passageway 64 extending therebetween. The cylindrical body 52 has a drain hole 66 and an entry way 68 formed through and between the cylindrical outer and inner surfaces 52a and 52b respectively. The damper assembly 54 is connected to the cylindrical body 52 at the inlet opening 60. The filter mounting structure 56 is connected to the cylindrical body 52 at the outlet opening 62. The stand structure 58 is operative to support the cylindrical body 52 above the support surface 33 in a manner such that the longitudinal axis L is oriented generally horizontally. The drain hole 66 is disposed in facial opposition to the support surface 33.

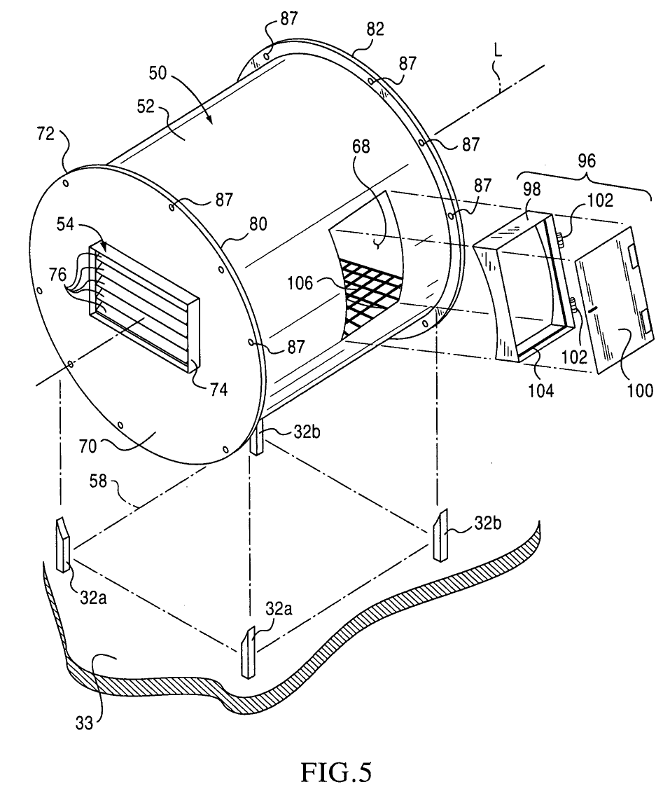

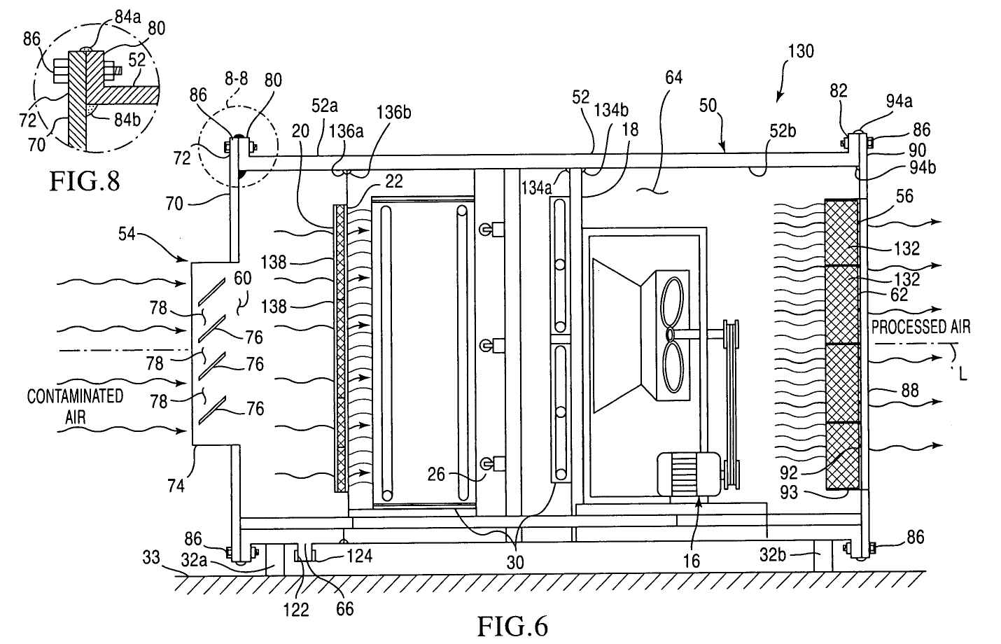

As best shown in FIGS. 5-7, the damper assembly 54 includes a disk-shaped damper assembly panel member 70 having an outer periphery 72 and a damper unit 74 mounted to the disk-shaped damper assembly panel member 70 with a plurality of movable vanes 76 that are operative for providing a variably-sized air inlet opening 78 to control an amount of contaminated air (represented by arrows entering into the passageway 64) flowing into the passageway 64. As best shown in FIGS. 6 and 8, the cylindrical body 52 and the disk-shaped damper assembly panel member 70 are connected to each other at the outer periphery 72 of the disk-shaped damper assembly panel member 72 as discussed in more detail below.

In FIGS. 4-6, the cylindrical body includes a first flange 80 surrounding the inlet opening 60 and a second flange 82 surrounding the outlet opening 62. Although not by way of limitation, the cylindrical body 52 and the disk-shaped damper assembly panel member 70 are integrally connected to each other at the outer periphery 72 of the disk-shaped damper assembly panel member 70 and the first flange 80 as best shown in FIG. 8. More specifically, as shown in FIG. 8, the disk-shaped damper assembly panel member 70 and the first flange 80 of the cylindrical body 52 are integrally connected to each other by weldments 84a and 84b. A skilled artisan would appreciate that such connection might be made by only a single one of weldments 84a or 84b. Also, the disk-shaped damper assembly panel member 70 and the cylindrical body 52 are connected to each other by fasteners 86 such as bolt and nut arrangements through respective bolt holes 87. The bolt and nut arrangement facilitates easy alignment and connection between the disk-shaped damper assembly panel member 70 and the cylindrical body 52 before the weldments 84a and 84b are made. Alteratively, the disk-shaped damper assembly panel member 70 and the cylindrical body 52 can be connected to each other by welding in lieu of the fasteners mentioned above. As shown in FIGS. 4-8, the flanges 80 and 82 extend radially outwardly relative to and from the hollow cylinder body 52. However, one of ordinary skill in the art would appreciate that the flanges 80 and 82 are not limited to such radially-outward orientation but that the flanges 80 and 82 might, in the alternative, extend radially inwardly relative to and from the hollow cylinder body 52.

As shown in FIGS. 6, 9 and 10, the filter mounting structure 56 includes a disk-shaped filter mounting structure panel member 88 having an outer periphery 90 and a lattice of filter support members 92. By way of example only and as best shown in FIG. 9, the lattice of filter support members 92 form a plurality of columns A1 through A4 and a plurality of rows B1 through B4 of air outlet openings labeled A2B1, A3B1, A1B2, A2B2, A3B2, A4B2, A1B3, A2B3, A3B3, A4B3, A2B4, A3B4, to permit processed air (referred to by arrows) to flow out of the passageway 64. Also, the filter mounting structure 56 includes a plurality of mounting bars 93 projecting perpendicularly from the lattice of filter support members 92 at their respective crossing intersections. The disk-shaped filter mounting structure panel member 88 and the cylindrical body 52, as best shown in FIG. 6, are integrally connected to each other at the outer periphery 90 of the disk-shaped filter mounting structure panel member 88 and the second flange 82 of the cylindrical body 52 by weldments 94a and 94b. A skilled artisan would appreciate that such connection might be made by only a single one of weldments 94a or 94b. Also, the disk-shaped filter mounting structure panel member 88 and the second flange 82 are connected to each other by fasteners 86 such as bolt and nut arrangements through respective bolt holes 87 as discussed above. As suggested above, the bolt and nut arrangement facilitates easy alignment and connection between the disk-shaped filter mounting structure panel member 88 and the second flange 82 before the weldments 84a and 84b are made.

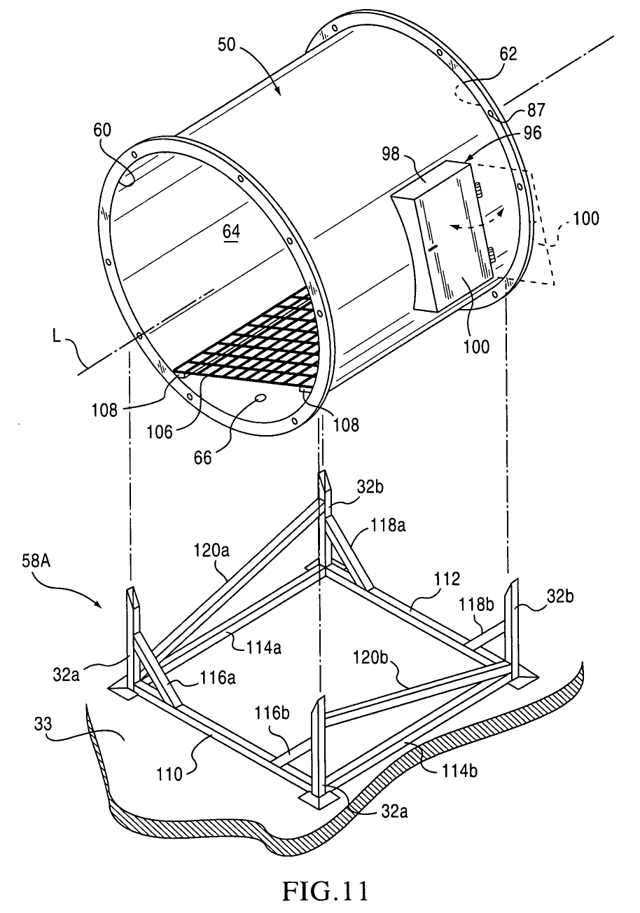

As shown in FIGS. 5 and 11, the housing unit 50 has a door assembly 96. The door assembly 96 includes a generally rectangularly-shaped door frame 98 and a door 100. The door frame 98 is connected to the cylindrical body 52 preferably by welding and surrounds the entry way 68. The door 100 is pivotably connected to the door frame 98 preferably by a pair of hinges 102 and is operative to move between an opened state illustrated in phantom in FIG. 11 and a closed, sealed state also illustrated in FIG. 11. In the closed, sealed state, the door 100 compresses a door frame seal 104 as is commonly known in the art to prevent leakage of contaminated air into the housing unit 50 during operations.

As shown in FIGS. 4 and 5, the housing unit 50 also has a walk-on grating 106. Although not by way of limitation, the walk-on grating 106 is preferably in a form of a removable grate structure or removable grate panels. The walk-on grating 106 extends longitudinally and laterally and is disposed within the passageway 64 between the inlet opening 60 and the outlet opening 62 and between the entry way 68 and the drain hole 66 so that a maintenance worker can walk or crawl on a flat flooring surface while performing maintenance in the passageway 64 of the housing unit 50. A pair of support rails 108 extends longitudinally along and in the passageway 64 and are connected to the cylindrical inner surface 52b to support the walk-on grating 106. Preferably, the walk-on grating 106 merely rests upon the pair of support rails 108 in a secure manner to permit the maintenance worker to walk or crawl on the walk-on grating 106 while simultaneously permitting easy removal of the walk-on grating 106 by the maintenance worker, if desired.

As shown in FIG. 5, the stand structure 58 includes the first pair of legs 32a, 32a and the second pair of legs 32b, 32b. The first and second pairs of legs 32a, 32a, 32b, 32b are connected to and depend downwardly from the outer surface 52a of the cylindrical body 52. The first pair of legs 32a, 32a are disposed apart and diametrically from one another adjacent the inlet opening 60 with the longitudinal axis L positioned between the first pair of legs 32a, 32a. The second pair of legs 32b, 32b are disposed apart and diametrically from one another adjacent the outlet opening 62 with the longitudinal axis L positioned between the second pair of legs 32b, 32b.

A different stand structure 58A is illustrated in FIG. 11. In addition to the includes the first pair of legs 32a, 32a and the second pair of legs 32b, 32b described above, the stand structure 58A includes a first cross member 110 and a second cross member 112. The first cross member 110 interconnects the first pair of legs 32a, 32a and is disposed adjacent to or in contact with the support surface 33 and the second cross member interconnects the second pair of legs 32b, 32b and is disposed adjacent to or in contact with the support surface 33. The stand structure also includes a pair of longitudinal support members 114a and 114b which extend longitudinally in parallel with the longitudinal axis L. Respective ones of the pair of longitudinal support members 114a, 114b interconnect respective opposing ones of the first and second pairs of legs 32a, 32b. The pair of longitudinal support members 114a, 114b are disposed adjacent to or in contact with the support surface 33.

The stand structure 58A further includes a first pair of laterally-angled brace members 116a and 116b and a second pair of laterally-angled brace members 118 a and 118b. Respective ones of the first pair of laterally-angled brace members 116a, 116b interconnect respective ones of the first pair of legs 32a, 32b and the first cross member 110 and respective ones of the second pair of the laterally-angled brace members 118a, 118b interconnect respective ones of the second pair of legs 32b, 32b and the second cross member 112. Additionally, the stand structure 58A includes a pair of longitudinally-angled brace members 120a and 120b. Respective ones of the longitudinally-angled brace members 120a, 120b interconnect respective opposing ones of the first and second pairs of legs 32a, 32a, 32b and 32b. More specifically, the longitudinally-angled brace member 120a interconnects leg 32a and leg 32b while the longitudinally-angled brace member 120b interconnects the remaining ones of legs 32a and 32b as shown in FIG. 11.

Again, with reference to FIG. 6, the housing unit 50 has a nipple 122 surrounding the drain hole 66 that connects to and projects from the outer surface 52a of the housing unit 50. A cap 124 is removably connected to the nipple 122, preferably by being threadably and sealably connected together as is commonly known in the industry. A skilled artisan would appreciate that the nipple 122 and the cap 124 are to be threadably and sealably connected to each other during operations and are easily disconnected from each other during cleaning and maintenance of the housing unit 50.

Another exemplary embodiment of the present invention is a critical process air handling unit 130 shown by way of example in FIG. 6. The critical process air handling unit 130 is adapted to intake contaminated air (represented by arrows before the damper assembly 54) for processing as air passes therethrough and to output processed air (represented by arrows after the filter mounting structure 56). The critical process air handling unit includes the housing unit 50, the damper assembly 54, the filter mounting structure 56 and at least one filter 132 mounted to the filter mounting structure 56 with the passageway 64 being adjacent the outlet opening 62, the fan assembly 16, the pre-filter mounting structure 20, at least one pre-filter 138, the UV light assembly 26, the heat exchanger unit 30, the stand structure 58 or 58A and the walk-on grating 106.

The fan assembly 16 is connected to the inner surface 52b of the cylindrical body 52 within the passageway 64 via the fan assembly wall 18. Preferably, the fan assembly wall 18 is welded to the inner surface 52b of the cylindrical body 52 by weldments 134a and 134b. The pre-filter mounting structure 20 is connected to the inner surface 52b of the cylindrical body 52 within the passageway 64 via the pre-filter mounting structure wall 22. Preferably, the pre-filter mounting structure 20 welded to the inner surface 52b of the cylindrical body 52 by weldments 136a and 136b. The at least one pre-filter 138 is mounted to the pre-filter mounting structure 20. The UV light assembly 26 is connected to the inner surface 52b of the cylindrical body 52 within the passageway 64 and is operative to reduce air contaminants such as air-borne germs and bacteria. The heat exchanger unit 30 is connected to the inner surface 52b of the cylindrical body 52 within the passageway 64.

Upon energizing the UV light assembly 26, the heat exchanger unit 30 and the fan assembly 16, the contaminated air is drawn through the damper assembly 54, the at least one pre-filter 138, the heat exchanger unit 30 and the UV light assembly 26 and is forced through the at least one filter thereby outputting the processed air as de-contaminated, filtered and selectively heated or cooled relative to the contaminated air.

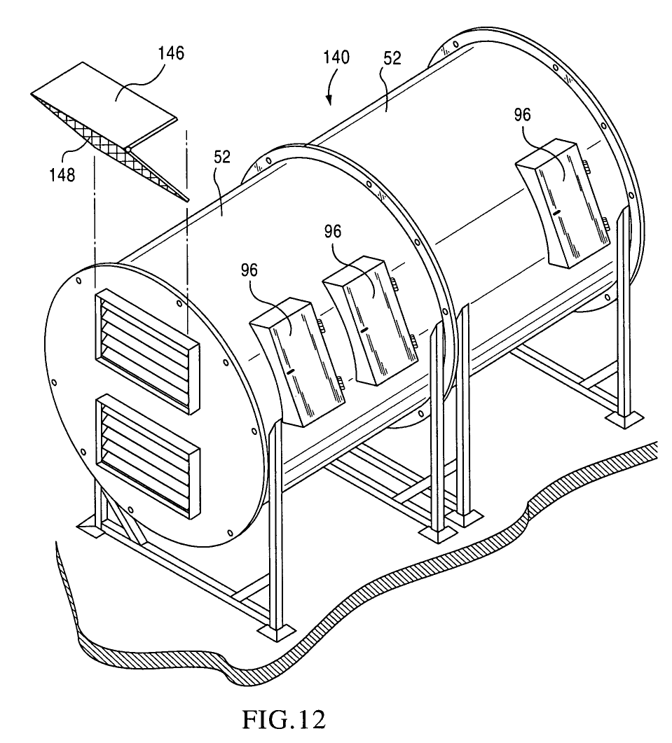

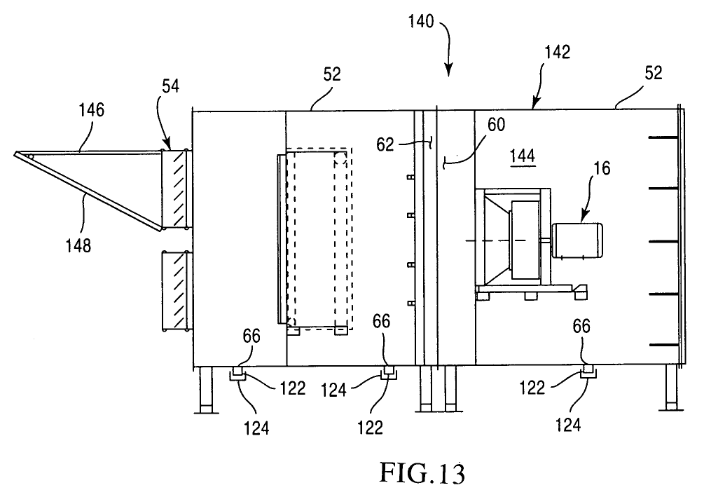

Note that the critical process air handling unit 130 includes only one door assembly 96 and one drain hole 66 along with its associated nipple 122 and cap 124. However, as shown in FIGS. 12 and 13, another embodiment of the critical process air handling unit 140 of the present invention includes a plurality of door assemblies 96 and a plurality of drain holes 66 along with their associated nipples 122 and caps 124. Thus, a skilled artisan would appreciate that the critical process air handling unit includes at least one door assembly 96 and at least one drain hole 66 along with its associated nipple 122 and cap 124.

Further, the critical process air handling unit 140 has a housing 142 that includes two hollow cylindrical bodies 52 integrally connected together at corresponding, facially-opposing inlet and outlet openings 62 and 60 respectively to form a continuous passageway 144 through and between the two integrally connected cylindrical bodies 52, 52. A skilled artisan would appreciate that additional housings 142 can be interconnected to further elongate the continuous passageway 144. Thus, the critical process air handling unit 140 has at least two hollow cylindrical bodies 52, 52 integrally connected together as described.

Additionally, the critical process air handling unit 140 has a cover 146 connected to the damper assembly 54 and a screen 148 connected to the cover 146 and the damper assembly 54 to prevent, for example, bugs and other debris, from entering the housing unit.

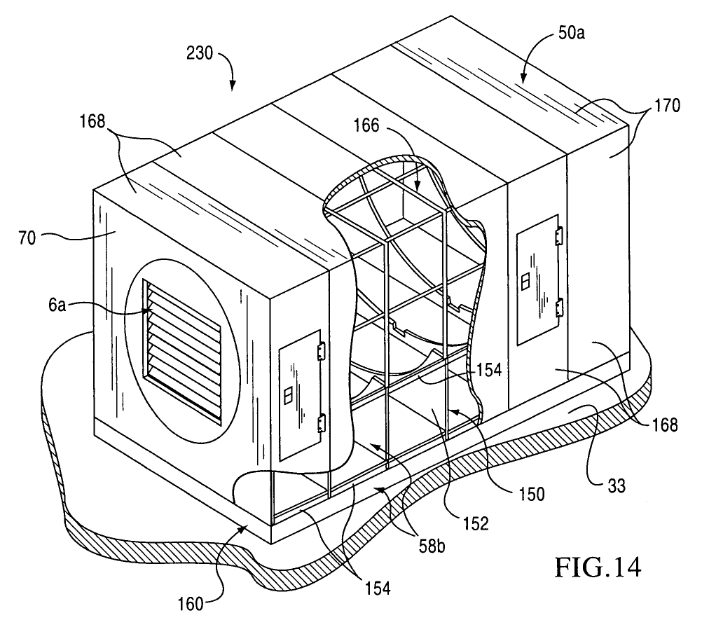

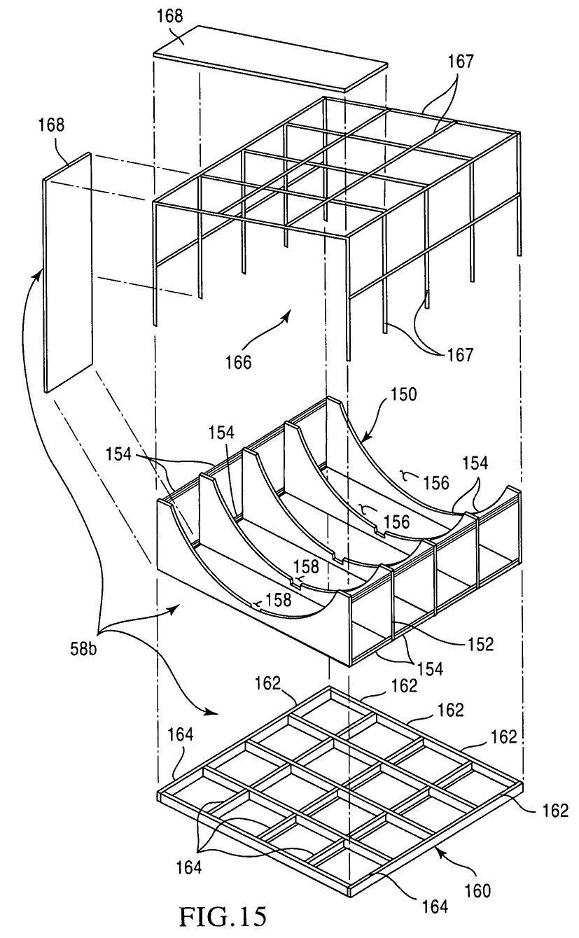

Another exemplary embodiment of the present invention is a critical process air handling unit 230 as illustrated in FIGS. 14 and 15 that is similar to the above but with a modified damper assembly 6a and with a modified housing unit 50a. The modified damper assembly 6a occupies a substantial portion of the disk-shaped damper assembly panel member 70. The modified housing unit 50a includes a modified stand structure 58b. The modified stand structure 58b includes a cradle assembly 150 as best shown in FIG. 15. The cradle assembly 150 has a plurality of cradle members 152 disposed apart from one another in a generally parallel manner and are connected to each other by longitudinally-extending connecting members 154 that are disposed between consecutive ones of the plurality of cradle members 152. Each cradle member 152 extends laterally and has an arcuate-shaped recess 156 sized and adapted to receive the cylindrical body 52 (as best shown in FIG. 5). For each cradle member 152, a rectangular notch 158 is positioned centrally within and at the bottom of the recess 156.

Also, as shown in FIGS. 14 and 15, the stand structure 58b includes a lattice support assembly 160 having a plurality of longitudinally extending lattice support members 162 and a plurality of laterally extending lattice support members 164 that are connected together. The lattice support assembly 160 is disposed on the support surface 33 and between the support surface 33 and the cradle assembly 150 as best shown in FIG. 14.

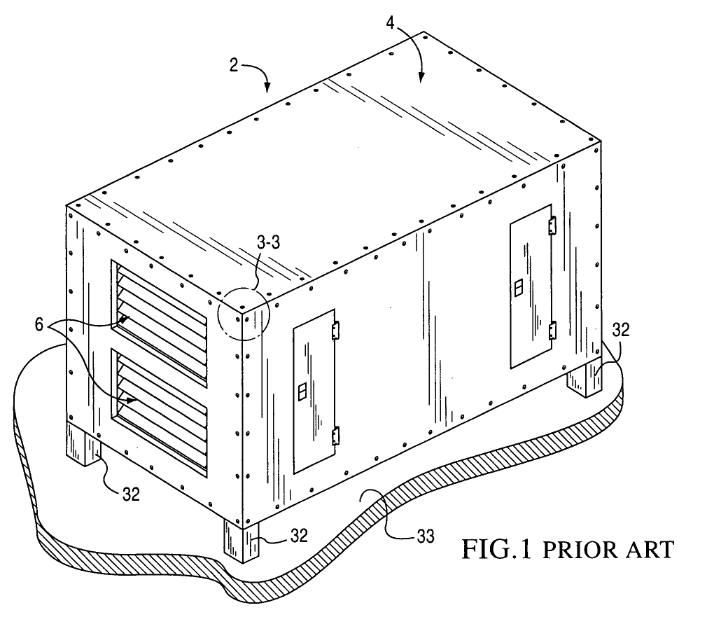

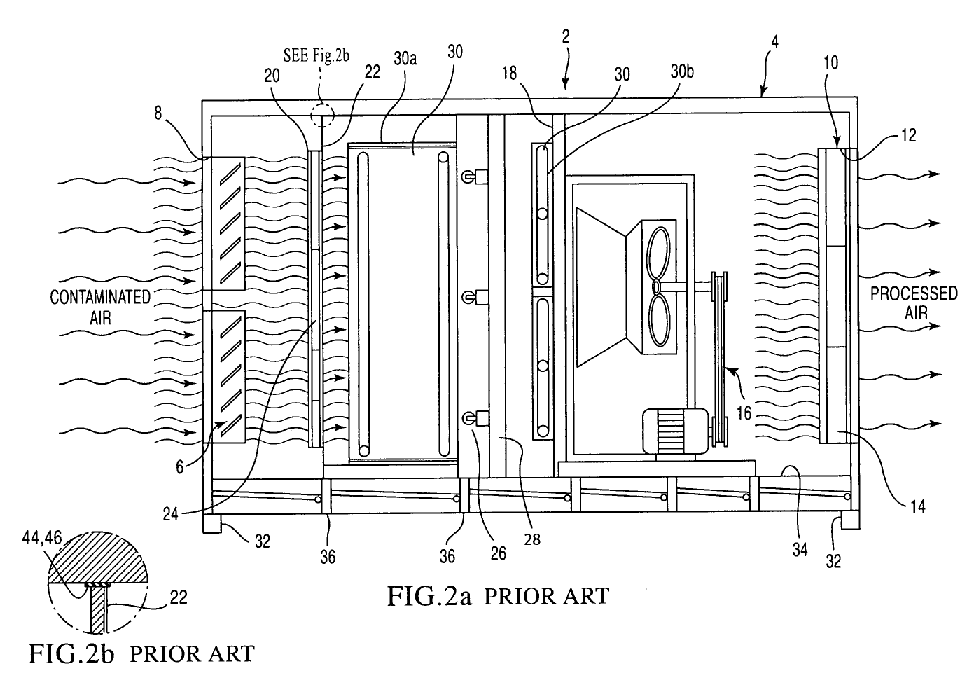

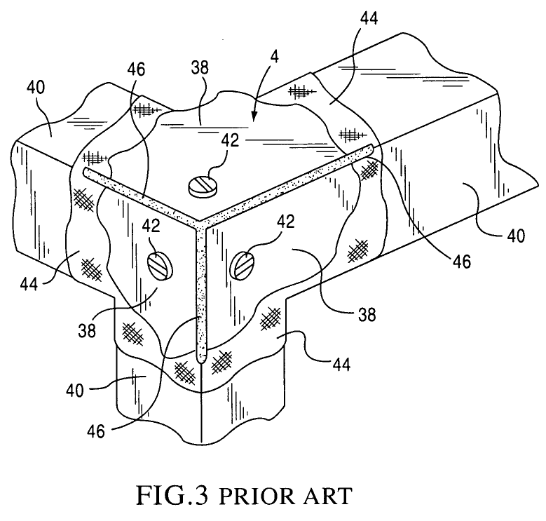

By way of example only and not by way of limitation, the stand structure 58b of the housing unit 50a includes a framework 166. The framework 166 has a plurality of frame members 167 connected together in a criss-crossing manner as best shown in FIG. 15. The criss-crossing frame members 167 form an inverted, squared U-shaped configuration (FIG. 15) that extends along the cylindrical body (FIG. 14). The framework 166 is connected to the cradle assembly 150. Additionally, the stand structure 58b includes a plurality of panel members 168. As best shown in FIG. 14, respective ones of the plurality of panel members are connected to the framework 166 and the cradle assembly 150 by conventional fastening means such as by screws, bolts and nuts, welding or the like to form a box-shaped cover 170 that extends over and about the cylindrical body 52. Thus, although this embodiment appears to be configured as shown in the prior art such as shown in FIG. 1, the interior of the critical process air handling unit of the present invention is cylindrical.

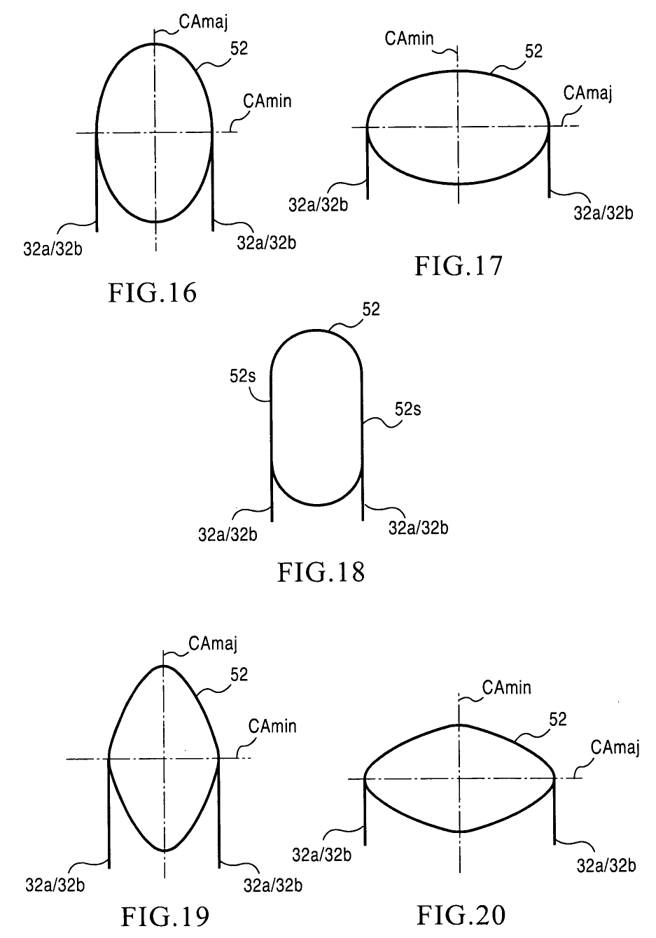

As described above, the front elevational views of the housing unit 50 of the embodiments of the present invention have been illustrated with the hollow cylindrical body 52 as being shaped in cross-section as a circle. However, a skilled artisan would appreciate that the hollow cylindrical body 52 can be adapted for other cross-sectional configurations as shown in FIGS. 16-20 without departing from the spirit and concepts of the present invention. FIG. 16 illustrates that the hollow cylindrical body 52 is formed in cross-section in an oval shape with its major central axis CAmaj oriented vertically and its minor central axis CAmin oriented horizontally. FIG. 17 illustrates that the hollow cylindrical body 52 is formed in cross-section in an oval shape with its major central axis CAmaj oriented horizontally and its minor central axis CAmin oriented vertically. One of ordinary skill in the art would appreciate that implementing the hollow body 52 illustrated in FIG. 17 might eliminate the use of the walk-on grating 106. FIG. 18 illustrates that the hollow cylindrical body 52 is formed in cross section in an oval shape with an opposing pair of parallel straight side portions 52s. FIG. 19 illustrates that the hollow cylindrical body 52 is formed in cross-section in an elliptical shape with its major central axis CAmaj oriented vertically and its minor central axis CAmin oriented horizontally. FIG. 20 illustrates that the hollow cylindrical body 52 is formed in cross-section in an oval elliptical shape with its major central axis CAmaj oriented horizontally and its minor central axis oriented vertically. One of ordinary skill in the art would appreciate that implementing the hollow cylindrical body 52 illustrated in FIG. 20 might eliminate the use of the walk-on grating 106. Thus, a skilled artisan would comprehend that that the hollow cylindrical body 52 is generally cylindrical in shape as illustrated by way of examples only in the drawing figures and not by way of limitation and, correspondingly, the hollow body would have a generally cylindrical outer surface and a generally cylindrical inner surface.

It is preferred that the housing of the present invention be fabricated from metal material. However, the housing might be fabricated from a resin material such as fiber glass to yield the same advantages and benefits.

The housing unit of the present invention alone or incorporated as a cylindrical critical process air handling unit minimizes the use of gaskets and caulking in comparison with the box-shaped configurations in the prior art. Therefore, leakage of contaminated air into the interior thereof is minimized during operations. Potential gasket or seal leaks could now be limited to the door assembly or door assemblies and the cap and nipple or caps and nipples. Also, the housing unit of the present invention alone or incorporated as a cylindrical critical process air handling unit has a reduced number of corners, particularly three-dimensional corners, relative to the prior art. As a result, cleaning of its interior is simplified.

The present invention, may, however, be embodied in various different forms and should not be construed as limited to the exemplary embodiments set forth herein; rather, these exemplary embodiments are provided so that this disclosure will be thorough and complete and will fully convey the scope of the present invention to those skilled in the art.

What is claimed is:

1. A housing unit, comprising:
a hollow generally cylindrical body extending along and about a longitudinal axis and having a generally cylindrical outer surface and a generally cylindrical inner surface defining an inlet opening, an outlet opening and a passageway extending therebetween, the generally cylindrical body having a drain hole and an entry way formed through and between the inner and outer surfaces;
a damper assembly connected to the generally cylindrical body at the inlet opening;
a filter mounting structure connected to the generally cylindrical body at the outlet opening; and
a stand structure operative to support the generally cylindrical body above a support surface in a manner such that the longitudinal axis is oriented generally horizontally and the drain hole is disposed in facial opposition to the support surface.

2. A housing unit according to claim 1, wherein the damper assembly includes a disk-shaped damper assembly panel member having an outer periphery and a damper unit mounted to the disk-shaped damper assembly panel member with a plurality of movable vanes operative for providing a variably-sized air inlet opening to control an amount of contaminated air flowing into the passageway, the generally cylindrical body and the disk-shaped damper assembly panel member connected to each other at the outer periphery of the disk-shaped damper assembly panel member.

3. A housing unit according to claim 2, wherein the disk-shaped damper assembly panel member and the generally cylindrical body are integrally connected to each other by a weldment.

4. A housing unit according to claim 1, wherein the filter mounting structure includes a disk-shaped filter mounting structure panel member and a lattice of filter support members forming a plurality of columns and rows of air outlet openings to permit processed air to flow out of the passageway.

5. A housing unit according to claim 4, wherein the disk-shaped filter mounting structure panel member and the generally cylindrical body are integrally connected to each other by a weldment.

6. A housing unit according to claim 1, further comprising a door assembly including a door frame connected to the generally cylindrical body and surrounding the entry way and a door pivotably connected to the door frame and operative to move between an opened state and a closed, sealed state.

7. A housing unit according to claim 1, wherein the generally cylindrical body includes a first flange surrounding the inlet opening and a second flange surrounding the outlet opening, the damper assembly including a disk-shaped damper assembly panel member having an outer periphery and a damper unit mounted to the disk-shaped damper assembly panel member with a plurality of movable vanes operative for providing a variably-sized air inlet opening to control an amount of contaminated air to flow into the passageway, the generally cylindrical body and the disk-shaped damper assembly panel member being integrally connected to each other at the outer periphery of the disk-shaped damper assembly panel member and the first flange, the filter mounting structure including a disk-shaped filter mounting structure panel member and a lattice of filter support members forming a plurality of columns and rows of air outlet openings to permit processed air to flow out of the passageway, the disk-shaped filter mounting structure panel member and the generally cylindrical body being integrally connected to each other at the outer periphery of the disk-shaped filter mounting structure panel member and the second flange.

8. A housing unit according to claim 1, wherein the stand structure includes a first pair of legs and a second pair of legs connected to and depending downwardly from the outer surface of the generally cylindrical body, the first pair of legs disposed apart and diametrically from one another adjacent the inlet opening with the longitudinal axis positioned between the first pair of legs and the second pair of legs disposed apart and diametrically from one another adjacent the outlet opening with the longitudinal axis positioned between the second pair of legs.

9. A housing unit according to claim 8, wherein the stand structure includes a first cross member and a second cross member, the first cross member interconnecting the first pair of legs and being disposed adjacent to or in contact with the support surface, the second cross member interconnecting the second pair of legs and being disposed adjacent to or in contact with the support surface.

10. A housing unit according to claim 9, wherein the stand structure includes a pair of longitudinal support members extending longitudinally, respective ones of the pair of longitudinal support members interconnecting respective opposing ones of the first and second pairs of legs.

11. A housing unit according to claim 10, wherein the stand structure includes a first pair of laterally-angled brace members and a second pair of laterally-angled brace members, wherein respective ones of the first pair of laterally-angled brace members interconnect respective ones of the first pair of legs and the first cross member and respective ones of the second pair of the laterally-angled brace members interconnect respective ones of the second pair of legs and the second cross member.

12. A housing unit according to claim 11, wherein the stand structure includes a pair of longitudinally-angled brace members, respective ones of the longitudinally-angled brace members interconnecting respective opposing ones of the first and second pairs of legs.

13. A housing unit according to claim 1, further comprising a walk-on grating in a form of a grate structure, the walk-on grating extending longitudinally and laterally and disposed within the passageway between the inlet opening and the outlet opening and between the entry way and the drain hole.

14. A housing unit according to claim 1, wherein the stand structure includes a cradle assembly having a plurality of cradle members disposed apart from one another in a generally parallel manner and connected to each other by longitudinally-extending connecting members disposed therebetween, each cradle member extending laterally and having an arcuate-shaped recess sized and adapted to receive the generally cylindrical body.

15. A housing unit according to claim 14, wherein the stand structure includes a lattice support assembly having a plurality of longitudinally extending lattice support members and a plurality of laterally extending lattice support members connected together, the lattice support assembly being disposed on the support surface and between the support surface and the cradle assembly.

16. A housing unit according to claim 15, wherein the stand structure includes a framework having a plurality of frame members connected together in a criss-crossing manner to form an inverted, squared U-shaped configuration extending along the generally cylindrical body, the framework connected to the cradle assembly.

17. A housing unit according to claim 16, wherein the stand structure includes a plurality of panel members connected to the framework and the cradle assembly to form a box-shaped cover over and about the generally cylindrical body.

18. A critical process air handling unit adapted to intake contaminated air for processing as air passes therethrough and to output processed air, comprising:
a housing unit including at least one hollow generally cylindrical body extending along and about a longitudinal axis and having a generally cylindrical outer surface and a generally cylindrical inner surface defining an inlet opening, an outlet opening and a passageway extending therebetween, the at least one generally cylindrical body having a drain hole and an entry way formed through and between the inner and outer surfaces;
a damper assembly connected to the generally cylindrical body at the inlet opening and including a disk-shaped damper assembly panel member having an outer periphery and a damper unit mounted to the disk-shaped damper assembly panel member with a plurality of movable vanes operative for providing a variably-sized air inlet opening to control an amount of contaminated air flowing into the passageway, the generally cylindrical body and the disk-shaped damper assembly panel member integrally connected to each other at the outer periphery of the disk-shaped damper assembly panel member;
a filter mounting structure connected to the generally cylindrical body at the outlet opening and including a disk-shaped filter mounting structure panel member and a lattice of filter support members forming a plurality of columns and rows of air outlet openings to permit processed air to flow out of the passageway, the filter mounting structure including a disk-shaped filter mounting structure panel member and a lattice of filter support members forming a plurality of columns and rows of air outlet openings to permit processed air to flow out of the passageway, the disk-shaped filter mounting structure panel member and the generally cylindrical body being integrally connected to each other;
at least one filter mounted to the filter mounting structure with the passageway adjacent the outlet opening;
a fan assembly connected to the inner surface of the generally cylindrical body within the passageway;
a pre-filter mounting structure connected to the inner surface of the generally cylindrical body within the passageway;
at least one pre-filter mounted to the pre-filter mounting structure;
a heat exchanger unit connected to the inner surface of the generally cylindrical body within the passageway; and
a stand structure operative to support the generally cylindrical body above a support surface in a manner such that the longitudinal axis is oriented generally horizontally and the drain hole is disposed in facial opposition to the support surface;
wherein, upon energizing the heat exchanger unit and the fan assembly, the contaminated air is drawn through the damper assembly, the at least one pre-filter and the heat exchanger unit and forced through the at least one filter thereby outputting the processed air as de-contaminated, filtered and selectively heated or cooled relative to the contaminated air.

19. A critical process air handling unit according to claim 18, wherein the generally cylindrical body includes a first flange surrounding the inlet opening and a second flange surrounding the outlet opening, the damper assembly being integrally connected to each other at the outer periphery of the disk-shaped damper assembly panel member and the first flange by a weldment, the disk-shaped filter mounting structure panel member and the generally cylindrical body being integrally connected to each other at the outer periphery of the disk-shaped filter mounting structure panel member and the second flange by a weldment.

20. A critical process air handling unit according to claim 18, further comprising at least one door assembly, each at least one door assembly including a door frame connected to the at least one generally cylindrical body and surrounding the entry way and a door pivotably connected to the door frame and operative to move between an opened state and a closed, sealed state.

21. A critical process air handling unit according to claim 18, wherein the housing includes at least two hollow generally cylindrical bodies integrally connected together at corresponding, facially-opposing inlet and outlet openings to form a continuous passageway between the at least two integrally connected generally cylindrical bodies.

22. A critical process air handling unit according to claim 18, further comprising a UV light assembly connected to the inner surface of the generally cylindrical body within the passageway and operative to reduce air and surface contaminants, when energized.

23. A critical process air handling unit according to claim 18, further comprising a walk-on grating in a form of a grate structure, the walk-on grating extending longitudinally and laterally and disposed within the passageway between the inlet opening and the outlet opening and between the entry way and the drain hole.
